(19) United States
(12) Patent Application Publication
(10) Pub. No.: US 2024/0389040 A1
(43) Pub. Date: Nov. 21, 2024

(54) TERMINAL, AND BASE STATION

(71) Applicant: NTT DOCOMO, INC., Tokyo (JP)

(72) Inventors: Shohei Yoshioka, Chiyoda-ku, Tokyo (JP); Daisuke Kurita, Chiyoda-ku, Tokyo (JP); Satoshi Nagata, Chiyoda-ku, Tokyo (JP); Weiqi Sun, Haidian District, Beijing (CN); Jing Wang, Haidian District, Beijing (CN); Wenjia Liu, Haidian District, Beijing (CN); Lan Chen, Haidian District, Beijing (CN); Jinming Zhao, Haidian District, Beijing (CN); Yong Li, Haidian District, Beijing (CN)

(73) Assignee: NTT DOCOMO, INC., Tokyo (JP)

(21) Appl. No.: 18/689,033

(22) PCT Filed: Sep. 9, 2021
(86) PCT No.: PCT/JP2021/033225

§ 371 Date: Mar. 4, 2024

(51) Int. Cl. H04W 56/00; H04L 5/00

(52) U.S. Cl. CPC H04W 56/005; H04L 5/0048

(57) ABSTRACT

A terminal includes: a reception unit configured to receive a command that designates a first timing adjustment value and information from a base station; and a control unit configured to calculate a second timing adjustment value that is used for uplink transmission in a non-terrestrial network using the information and the first timing adjustment value.

### TECHNICAL FIELD

The present invention relates to a terminal and a base station in a radio communication system.

### BACKGROUND ART

In 3GPP (3rd Generation Partnership Project), in order to realize a further increase in system capacities, a further increase in data transmission rates, a further reduction in delays in radio sections, and the like, a radio communication scheme called 5G or NR (New Radio) (hereinafter, the radio communication scheme is referred to as “NR”) is being developed. In 5G, various radio technologies and network architectures have been studied in order to satisfy the requirement that the delay in a radio section be equal to or less than 10 Gbps while realizing a throughput equal to or greater than 1 ms.

Further, in NR, as in LTE, in order to align reception timings of uplink signals from a plurality of terminals, TA (Timing Advance) control is performed to adjust timings of transmitting signals from the terminals (Non-Patent Documents 1 and 2).

### RELATED ART DOCUMENT

### Non-Patent Documents

Non-Patent Document 1: 3GPP TS 38.213 V 16. 5.0 (2021-03)
Non-Patent Document 2: 3GPP TS 38.211 V 16. 5.0 (2021-03)

### SUMMARY OF THE INVENTION

### Problems to be Solved by the Invention

In 3GPP, studies on NTN (Non-Terrestrial Networks) are being conducted. TA control described above is also required in the NTN. In addition, in order to reduce power consumption of a terminal, a terminal which does not have a positioning function such as GNSS has been studied.

However, since the conventional TA control of the NTN is based on the premise that the terminal has a positioning function, there is a possibility that the TA control of the NTN cannot be appropriately performed when the terminal does not have the positioning function.

The present invention has been made in view of the above, and an object of the present invention is to provide a technique that enables a terminal to appropriately calculate a timing adjustment value in a non-terrestrial network even when the terminal does not have a positioning function.

### Means for Solving the Problems

According to the disclosed technique, there is provided a terminal including:
a reception unit configured to receive a command that designates a first timing adjustment value and information from a base station; and
a control unit configured to calculate a second timing adjustment value that is used for uplink transmission in a non-terrestrial network using the information and the first timing adjustment value.

### Effects of the Invention

According to the disclosed technique, a technique is provided that enables a terminal to appropriately calculate a timing adjustment value in a non-terrestrial network even when the terminal does not have a positioning function.

### BRIEF DESCRIPTION OF THE DRAWINGS

FIG. 1 is a diagram for explaining a radio communication system according to an embodiment of the present invention;

FIG. 2 is a diagram showing an example of TA control;

FIG. 3 is a diagram for explaining a radio communication system according to an embodiment of the present invention;

FIG. 4 is a diagram for explaining a radio communication system according to an embodiment of the present invention;

FIG. 5 is a diagram showing an example of TA control;

FIG. 6 is a diagram showing an example of Rel-18 reference point;

FIG. 7 is a sequence diagram for explaining an operation example;

FIG. 8 is a sequence diagram for explaining an operation example;

FIG. 9 is a diagram for explaining case 1;

FIG. 10 is a diagram for explaining case 2;

FIG. 11 is a diagram showing an example of a functional configuration of a base station 10 according to an embodiment of the present invention;

FIG. 12 is a diagram showing an example of a functional configuration of a terminal 20 according to an embodiment of the present invention;

FIG. 13 is a diagram showing an example of a hardware configuration of the base station 10 or the terminal 20 according to an embodiment of the present invention;

FIG. 14 is a diagram showing a configuration of a vehicle.

### DETAILED DESCRIPTION OF THE INVENTION

Hereinafter, an embodiment of the present invention will be described with reference to the drawings. The embodiment described below is an example, and the embodiment to which the present invention is applied is not limited to the following embodiment.

Although the radio communication system according to the embodiment of the present invention is assumed to be NR or 6G system, the technique according to the present invention is not limited to NR or 6G and can be applied to other systems.

In addition, although the present specification uses terms used in the existing NR or LTE specifications, such as PDCCH, PDSCH, PUSCH, RRC, MAC, and DCI, those represented by channel names, protocol names, signal names, function names, and the like used in the present specification may be referred to by other names.

### (TA Control)

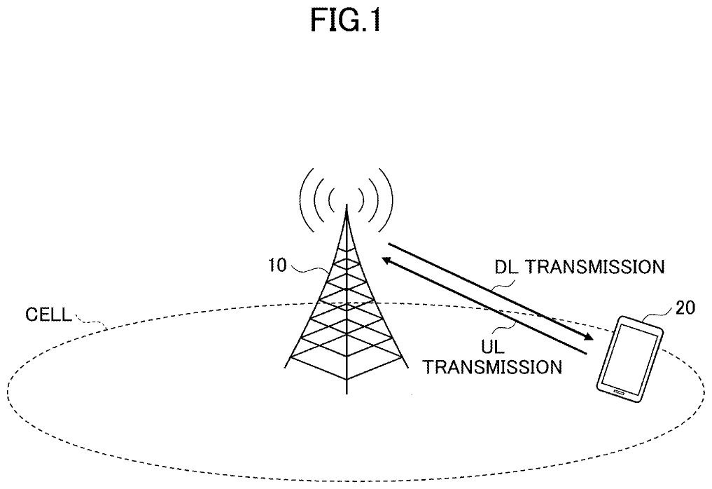

First, TA control will be described by taking as an example the configuration of a terrestrial radio communication system including a base station 10 and a terminal 20 as shown in FIG. 1. The base station 10 may be referred to as a gNB, and the terminal 20 may be referred to as a UE.

The TA (Timing Advance) control is a control for uplink (UL) transmission of the terminal 20, and is a control for shifting an UL frame by a certain time (T_{TA}) with respect to a downlink (DL) frame.

More specifically, due to a difference in propagation delay between the base station 10 and a plurality of terminals 20, when the TA control is not performed, timings of UL signals received from the plurality of terminals 20 are not aligned in the base station 10. Therefore, TA control is performed so that reception timings at the base station 10 are aligned for transmission of each terminal 20.

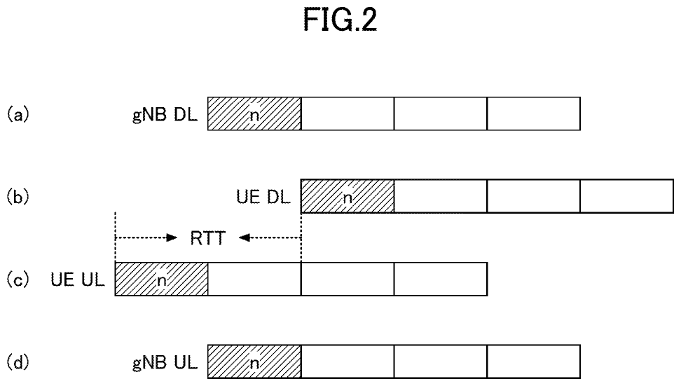

A specific example will be described with reference to FIG. 2. In FIG. 2, for convenience of explanation, one rectangle is one slot, and the slot n is shown by hatching. For convenience of description, it is assumed that a round trip time (RTT) between the base station 10 and the terminal 20 is two slots. (a) and (b) show that a signal of DL transmission of the base station 10 in the slot n arrives at the terminal 20 with a delay of one slot. As illustrated in (c) and (d), the terminal 20 performs UL transmission at a timing advanced by the RTT with respect to the timing of DL reception, and thus the base station 10 receives UL transmission from the terminal 20 at the timing of its own slot n. Each terminal 20 performs such control, and thus the base station 10 can receive UL signals from a plurality of terminals 20 at the same timing.

### (System Configuration of NTN and TA Control)

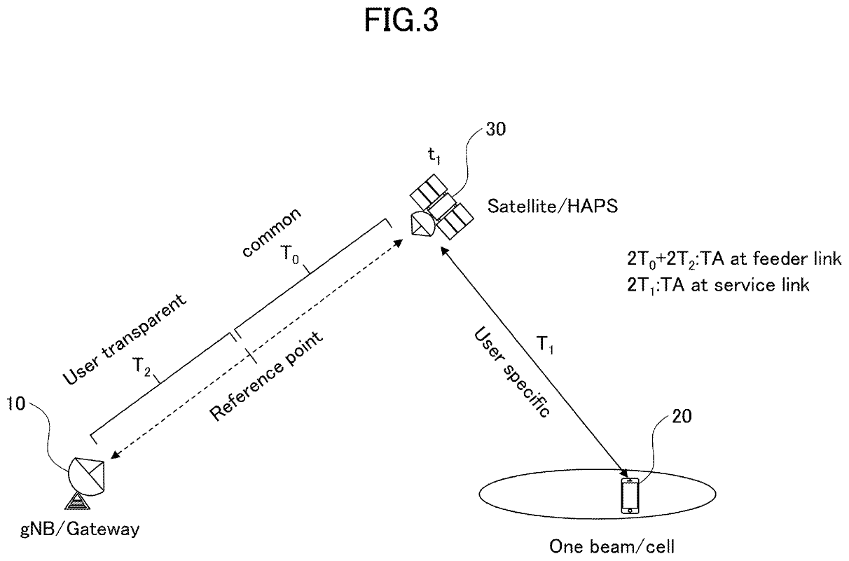

FIG. 3 shows an example of the configuration of a radio communication system according to the present embodiment. The radio communication system according to the present embodiment is a system of NTN (Non-Terrestrial Networks). Note that the “NTN (Non-Terrestrial Networks)” in the present embodiment refers to all systems that perform communication between a terminal and a base station via a relay apparatus (e.g., a satellite, an airplane, a drone, or the like) in the air, and includes HAPS (High-Altitude Platforms) and the like.

As illustrated in FIG. 3, the radio communication system according to the present embodiment includes a terminal 20 on the ground, a satellite 30 in the air (which may be an unmanned airplane of HAPS or the like), and a base station 10 on the ground. The base station 10 communicates with the satellite 30 via a gateway. The gateway and the base station may be collectively referred to as a “base station”. In addition, when the function of the base station 10 is mounted on the satellite 30, the base station 10 in the following description may be replaced with the satellite 30.

A signal transmitted from the base station 10 reaches the satellite 30, and is transmitted from the satellite 30 to the terminal 20. A signal transmitted from the terminal 20 reaches the satellite 30, and is transmitted from the satellite 30 to the base station 10. A link between the base station 10 and the satellite 30 is called a feeder link, and a link between the terminal 20 and the satellite 30 is called a service link. The base station 10 may be referred to as a gNB, and the terminal 20 may be referred to as a UE.

The base station 10 is a communication apparatus that provides one or more cells and performs radio communication with the terminal 20 via the satellite 30. The physical resource of the radio signal is defined in a time domain and a frequency domain, and the time domain may be defined by the number of OFDM symbols, and the frequency domain may be defined by the number of subcarriers or the number of resource blocks. In addition, a transmission time interval (TTI) in the time domain may be a slot, and a TTI may be a subframe.

The base station 10 can perform carrier aggregation in which a plurality of cells (a plurality of component carriers (CCs)) are aggregated to communicate with the terminal 20. In carrier aggregation, one PCell (primary cell) and one or more SCells (secondary cells) are used.

The base station 10 transmits a synchronization signal, system information (SIB and the like), and the like to the terminal 20. The base station 10 transmits a control signal or data to the terminal 20 in downlink (DL), and receives a control signal or data from the terminal 20 in uplink (UL). Note that, although what is transmitted in a control channel such as PUCCH and PDCCH is referred to as a control signal and what is transmitted in a shared channel such as PUSCH and PDSCH is referred to as data here, such a way of referring to PUSCH and PDSCH is merely an example.

The terminal 20 is a communication apparatus that includes an antenna capable of communicating with the satellite 30 and has a function of performing radio communication with the base station 10 via the satellite 30. The terminal 20 receives a control signal or data from the base station 10 in DL and transmits a control signal or data to the base station 10 in UL, thereby using various communication services provided by the radio communication system.

The terminal 20 can also perform carrier aggregation in which a plurality of cells (a plurality of component carriers (CCs)) are aggregated to communicate with the base station 10. In carrier aggregation, one PCell (primary cell) and one or more SCells (secondary cells) are used. Also, a PUCCH-SCell with a PUCCH may be used.

Note that the terminal 20 may have a GNSS positioning function, but in the present embodiment, it is assumed that the terminal 20 does not have a GNSS positioning function or does not use the function. The GNSS positioning function is an example of a positioning function held by the terminal 20.

### (TA in NTN)

In the NTN, Timing Advance (TA) control for adjusting transmission timing of a terminal is performed in order to match reception timing of uplink signals from a plurality of terminals in the base station 10.

In the TA control, for example, as described in 4.3.1 of Non-Patent Document 1, the terminal 20 transmits an uplink frame i corresponding to a downlink frame i before the start timing of the downlink frame i by T_{TA}. Note that in this embodiment, T_{TA} is referred to as “TA” in some cases. The TA may be referred to as a timing adjustment value. Further, each of N_{TA}, N_{TA,UE-common}, N_{TA,common}, and the like may be referred to as a timing adjustment value. The terminal 20 performs signal transmission at a timing based on the reception timing of the signal and the timing adjustment value.

In the NTN according to the present embodiment, TA (Full TA) is as follows.

Full TA=TA on feeder link+TA on service link

The TA on the feeder link is a value corresponding to a round trip delay (RTT) in the feeder link, and is 2 (T₀+T₂) as shown in FIG. 3.

As shown in FIG. 3, T₂ is a value transparent to the UE and compensated by the network. T₀ simplify gNB implementation, T₂ may be a constant. T₀ is a value common to all UEs, and may be a value that can be broadcast to terminals 20 by a SIB, for example. The reference point (RP) may be provided in the service link, and in that case, T₀ has a negative value.

The TA on the service link is a value corresponding to a round trip delay (RTT) on the service link, and is 2T₁ as shown in FIG. 3. T₁ is a UE-specific value and varies depending on the location of the UE.

Basically, the terminal 20 can calculate its own T_{TA} from the UE-specific TA (2T₁) estimated (calculated) by the terminal 20 itself and the common TA (2T₀), for example, by the following equation. The following equation is a calculation equation of T_{TA} assumed in NTN of Rel-17.

$${T}_{TA} = ( {N}_{TA} + {N}_{TA , UE - specific} + {N}_{TA , common} + {N}_{TA , offset} ) \times {T}_{c}$$

The above-mentioned T_{c} is a predetermined time length. Regarding N_{TA} in the above equation, it is 0 at the time of PRACH transmission, and is updated with a TA command of RAR, and then updated with a TA command MAC CE. In the first UL transmission after the RAR, N_{TA}=T_{A}·16·64/2^{μ}, and T_{A} (=0, 1, 2, . . . , 3846) is a value notified by a 12-bit TAC field in the RAR. In other transmissions, N_{TA_new}=N_{TA,old}+(T_{A}−31)·16·64/2^{μ}, and T_{A} (=0, 1, 2, . . . , 63) is signaled by a 6-bit TAC field in the T_{A} command MAC CE.

N_{TA,UE-specific} is a TA that a UE estimates for compensation of the service link delay. N_{TA,common} is a common TA controlled by the network, including a timing offset required in the network. Note that the value of N_{TA,common} may be assumed to be 0 (that is, it may be assumed that the UL frame and the DL frame are aligned at the satellite 30). N_{T,offset} is a fixed offset value used to calculate a TA.

Note that N_{TA,common} is an example of a common timing adjustment value based on a delay that occurs between the relay apparatus (satellite 30) and the base station 10 in the non-terrestrial network.

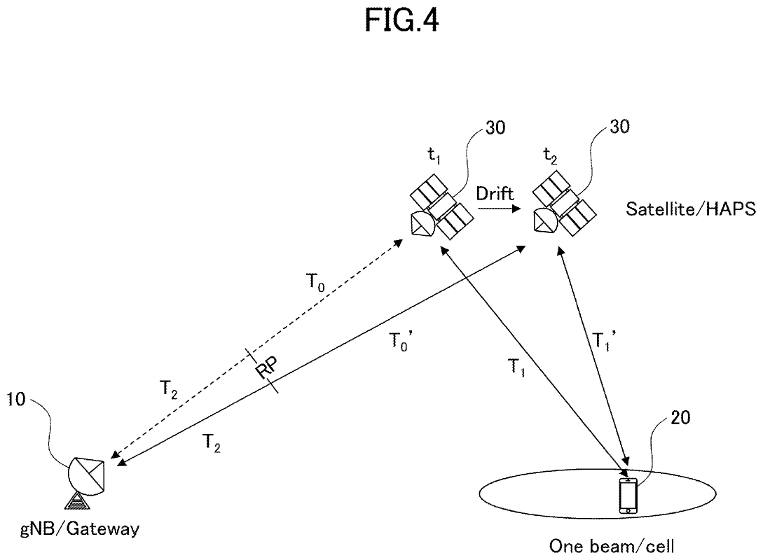

In the present embodiment, a TA drift rate generated in association with the movement of the satellite 30 is also taken into consideration. That is, as shown in FIG. 4, the TA changes due to the movement (drift) of the satellite 30. This change (change per unit time) is called a TA drift rate. As the TA drift rate, there are a common TA drift rate which is common to UEs and a UE-specific TA drift rate which is UE-specific. As shown in FIG. 4, assuming that T₀ and T₁ at time t₁ become T₀′ and T₁′ at time t₂, the common TA drift rate and the UE-specific TA drift rate are as follows.

$$Common TA drift rate = ( {T}_{0}^{′} - {T}_{0} ) / ( {t}_{2} - {t}_{1} )$$

UE-specific TA drift rate=(T₁′−T₁)/(t₂−t₁)

In the present embodiment, as described later, in the TA calculation, the UE uses the reference point (Rel-18 RP) instead of the position measured by the GNSS positioning function, and thus the UE common drift rate may be used instead of the UE specific TA drift rate.

In FIG. 4, the UE common drift rate is “(T₁′−T₁)/(t₂−t₁)” when the position of the terminal 20 is set to the position of the reference point (Rel-18 RP).

### (Estimation of TA Command by the Base Station 10)

The base station 10 calculates (estimates) a TA command (the above-described N_{TA}) to be transmitted by an RAR (Msg2 or MsgB) by using a reception timing of a PRACH transmitted from the terminal 20. Also, the base station 10 calculates (estimates) a TA command to be transmitted by a TA command MAC CE by using a signal transmitted from the terminal 20.

For example, as illustrated in FIG. 5, when the terminal 20 performs transmission at the DL reception timing, the base station 10 can estimate, as an RTT, the time from when the base station 10 transmits a DL signal to the terminal 20 to when the base station 10 receives an UL signal transmitted from the terminal 20.

However, in the mechanism of NTN of R17, when the base station 10 cannot know information about a TA estimated by the terminal 20, the base station 10 may not be able to estimate an RTT between the base station 10 and the terminal 20.

### (About Problems)

TA calculation in Rel-17 requires assistance from GNSS. That is, the terminal 20 obtains its precise position using the GNSS and uses that position to calculate the UE-specific delay between the terminal 20 and the satellite 30. However, the use of a GNSS positioning function increases power consumption. Therefore, in order to reduce power consumption, a terminal 20 that does not have a GNSS positioning function has been proposed.

However, the terminal 20 having no GNSS positioning function cannot calculate the TA by the existing method of Rel-17 NTN.

Specifically, the terminal 20 that does not have the GNSS positioning function cannot calculate N_{TA,UE-specific} by the existing method. Therefore, the terminal 20 cannot appropriately adjust timing of a PRACH or other UL transmission timings.

Hereinafter, Example 1 and Example 2 will be described as specific examples, but Example 0 will be described as an outline of these examples before describing Example 1 and Example 2.

### Example 0

In the present embodiment, the terminal 20 does not have a GNSS positioning function. The following description may be applied to a case where the GNSS positioning function is not used. The terminal 20 calculates T_{TA} using the following equation.

$${T}_{TA} = ( {N}_{TA} + {N}_{TA , UE - common} + {N}_{TA , common} + {N}_{TA , offset} ) \times {T}_{c}$$

The calculation method of each term in the above equation is as follows.

For N_{TA,common} and N_{T,offset}, existing techniques (for example, the Rel-17 method) can be used.

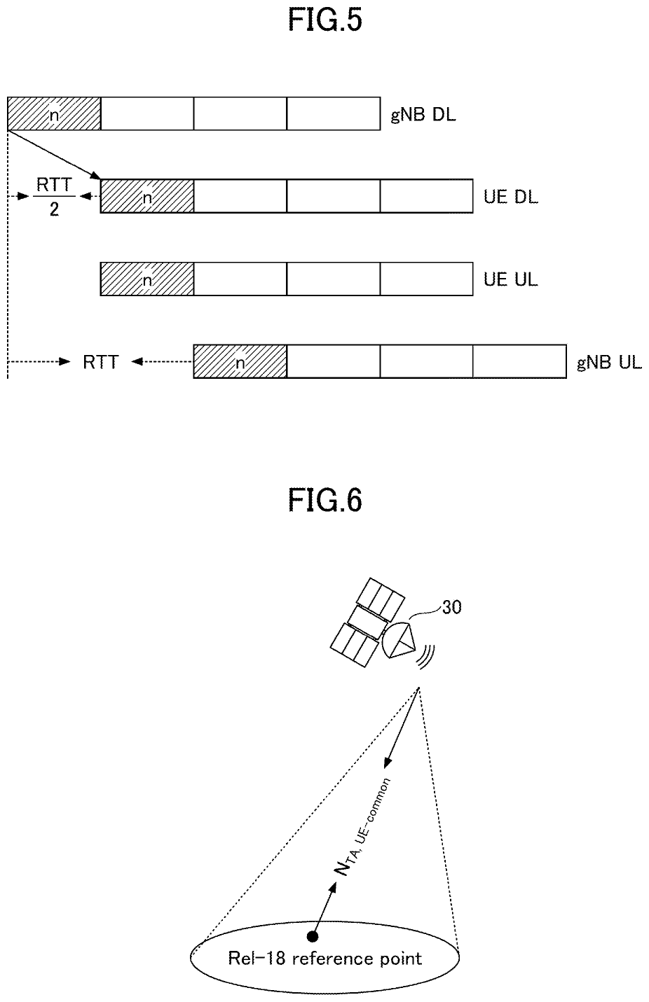

N_{TA, UE-common} is a new parameter. In the present embodiment, as shown in FIG. 6, Rel-18 reference point (RP) is introduced, and N_{TA,UE-common} is a delay (RTT) between the satellite 30 and the Rel-18 reference point (RP). All users (UEs) included in one beam use the same N_{TA,UE-common}. The Rel-18 reference point may be referred to as a fiducial point or a reference point. The terminal 20 can know the position of the Rel-18 reference point without using the GNSS positioning function. In the Example 1 described later, details on N_{TA,UE-common} will be described.

For N_{TA}, an enhancement of the TA command in the RAR (Msg2/MsgB) is made. However, the mechanism of Rel-17 may be reused.

Specifically, the range of the value notified by the RAR TA command is increased. Also, a negative TA value may be used. The details of N_{TA} will be described in Example 2 described later.

Further, for example, similarly to the mechanism of Rel-17, the drift rate may be notified from the base station 10 to the terminal 20, and the drift rate may be applied in the terminal 20.

Different drift rates may be notified and applied for N_{TA,common} and N_{TA,UE-common}. A common joint drift rate for N_{TA,common} and N_{TA,UE-common} may be signaled and applied.

### Example 1

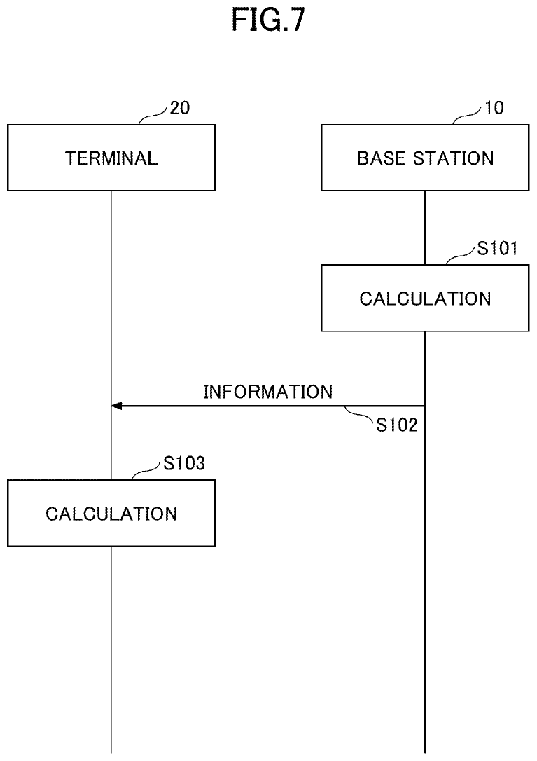

Next, Example 1 will be described. In the Example 1, N_{TA,UE-common} will be described in detail. FIG. 7 shows a flow of basic processing in the Example 1.

In S101, the base station 10 performs calculation to determine information to be transmitted in S102. In S102, the base station 10 transmits the information to the terminal 20. In S103 the terminal 20 calculates N_{TA,UE-common} using the information received from the base station 10. Note that, in some cases, the calculation in S101 is not performed for N_{TA,UE-common. In some cases, S103 calculation in S103 is not performed. Examples of “information” are described later.}

Example 1 includes option 1 and option 2. In option 1, in S102, the base station 10 notifies the terminal 20 of the position of the Rel-18 RP. In S103, the terminal 20 calculates N_{TA,UE-common} based on ephemeris (orbit information) of the satellite 30 and the notified position of the Rel-18 RP.

For example, the terminal 20 calculates the position of the satellite 30 from the ephemeris, calculates RTT between the position of the satellite 30 and the position of the RP based on the distance between the position of the satellite 30 and the position of the RP, and calculates N_{TA,UE-common} from the RTT. The base station 10 receives a signal transmitted from the terminal 20 at the timing based on N_{TA,UE-common}.

Notification of the reference point in S102 may be performed by any of a SIB, an RRC, a MAC CE, and a DCI.

In option 2, in S101, the base station 10 calculates N_{TA,UE-common}, and transmits it to the terminal 20 in S102. The method of calculating N_{TA,UE-common} in S101 is the same as the calculation method in the terminal 20. Option 2 includes the following option 2-1 and option 2-2.

Option 2-1: The base station 10 notifies the terminal 20 of N_{TA,UE-common} and N_{TA,common} separately. Note that, since it is defined in Rel-17 that N_{TA,common} is notified, option 2-1 is preferable to option 2-2.

Option 2-2: N_{TA,UE-common} is included in N_{TA,common}. The base station 10 notifies the terminal 20 of only the N_{TA,common}.

In option 2-2, the terminal 20 calculates T_{TA} by the following equation.

$${T}_{TA} = ( {N}_{TA} + {N}_{TA , common} + {N}_{TA , offset} ) \times {T}_{c}$$

As a variation of Example 1, the base station 10 and the terminal 20 may support both option 1 and option 2. In this case, for example, one of option 1 and option 2 may be applied depending on the case. Further, the base station 10 may notify the terminal 20 of an option to be applied, selected from option 1 and option 2. The notification may be performed by any of SIB, RRC, MAC CE, and DCI.

Further, the terminal 20 may transmit, to the base station 10, an option that the terminal 20 supports as capability information so that the terminal 20 carries out the supported option.

Hereinafter, detailed examples of option 1 and option 2 (specifically, option 2-2) will be described.

### Example 1: Detailed Example of Option 1

As a detailed example of option 1, an example of notification information of a position of Rel-18 RP will be described. As the notification information of the position of Rel-18 RP, for example, any of the following examples 1 to 4 can be used.

Example 1: The base station 10 notifies the terminal 20 of positions X, Y, and Z of ECEF as positions of Rel-18 RP.

Example 2: The base station 10 transmits, to the terminal 20, a position relative to the satellite 30 as a position of Rel-18 RP. For example, the coordinates of the satellite 30 are set to (0,0,0), and a position (X, Y, Z) of Rel-18 RP is notified as a relative position from the coordinates (0,0,0).

Example 3: The base station 10 notifies the terminal 20 of a relative position (X, Y, Z) or (X, Y) with respect to coordinates (0,0,0) or (0,0) determined based on an existing model as a position of Rel-18 RP. As an existing model, for example, the WGS84 model may be used in the same way as sidelink zone identifier calculation of 3GPP TS38.331.

Example 4: The base station 10 notifies the terminal 20 of LLA (latitude, longitude, and height) as the position of Rel-18 RP.

As a variation, the base station 10 may notify the terminal 20 of a distance between the position of the satellite 30 and the position of Rel-18 RP as information on the position of Rel-18 RP.

### Example 1: Detailed Example of Option 2-2

As described above, T_{TA} in option 2-2 of Example 1 is calculated by the following equation.

$${T}_{TA} = ( {N}_{TA} + {N}_{TA , common} + {N}_{TA , offset} ) \times {T}_{c}$$

N_{TA,common} in option 2-2 is enhanced as compared to N_{TA,common} in Rel-17 as follows.

In Rel-17, N_{TA,common} represents an RTT between the Rel-17 reference point and the satellite 30. In Rel-18, the enhanced N_{TA,common} is the sum of an RTT between the Rel-17 reference point and the satellite 30 and an RTT between the satellite 30 and the Rel-18 reference point.

N_{TA,common} in option 2-2 may have a different granularity compared to N_{TA,common} in Rel-17. N_{TA,common} in option 2-2 may be finer or coarser than N_{TA,common} in Rel-17.

Further, N_{TA,common} in option 2-2 may be notified from the base station 10 to the terminal 20 by a different signaling method compared to N_{TA,common} in Rel-17. The method of notifying N_{TA,common} in option 2-2 may be any of SIB, RRC, MAC CE, and DCI.

N_{TA,common} in option 2-2 may have a different periodicity compared to N_{TA,common} in Rel-17. For example, N_{TA,common} in option 2-2 may be updated/notified at a higher cycle or a lower cycle than N_{TA,common} in Rel-17.

### (Drift Rate)

In Example 1, the terminal 20 may calculate T_{TA} by applying a drift rate. In option 1, for example, the base station 10 may notify the terminal 20 of the above-described common TA drift rate and UE common drift rate, and the terminal 20 may calculate T_{TA} based on these values. For example, when a correction value by these drift rates is D, the terminal 20 may calculate T_{TA} by the following equation.

$${T}_{TA} = ( {N}_{TA} + {N}_{TA , UE - common} + {N}_{TA , common} + {N}_{TA , offset} + D ) \times {T}_{c}$$

Similarly, in option 2-1, the terminal 20 that has received the notification of D can calculate T_{TA} by the above equation. With respect to D, the terminal 20 may be notified of different drift rates for N_{TA,common} and N_{TA,UE-common}, or the terminal 20 may be notified of a joint drift rate common to N_{TA,common} and N_{TA,UE-common}.

In addition, in option 2-1, each of N_{TA,UE-common} and N_{TA,common} notified from the base station 10 to the terminal 20 may be a value after correction by the drift rate. In addition, in option 2-2, N_{TA,common} notified from the base station 10 to the terminal 20 may be a value after correction by the drift rate.

Next, as specific examples in Example 1, a specific example 1 and a specific example 2 will be described.

### Specific Example 1 of Example 1

In the specific example 1, the center point of the beam of the satellite 30 is used as a reference point to calculate N_{TA,UE-common}. The center point of the beam of the satellite 30 is the center point of the shape (for example, a circle) of the beam on the ground surface when the beam (for example, a cone shape as illustrated in FIG. 6) transmitted from the satellite 30 reaches the ground surface. The shape of the beam on the ground surface may be referred to as a coverage area, a cell, a service area, or the like. Note that, for a shape (service area) other than a shape such as a circle or an ellipse in which the center point is clearly defined, the center of gravity of the shape may be used as the center point.

Hereinafter, a case where the terminal 20 is in an RRC idle/inactive state and a case where the terminal 20 is in an RRC connected state will be described separately. The following option 1 and option 2 corresponds to the above-described option 1 and option 2 respectively.

### Specific Example 1 of Example 1: Case of RRC Idle/Inactive

In option 1, the base station 10 notifies or broadcasts the position of the reference point to the terminal 20, and the terminal 20 calculates N_{TA,UE-common} and uses the calculated N_{TA,UE-common} for TA calculation.

In option 2, the base station 10 calculates N_{TA,UE-common} and notifies or broadcasts the calculated N_{TA,UE-common} to the terminal 20. The terminal 20 calculates TA using N_{TA,UE-common} notified from the base station 10. Note that “N_{TA,UE-common}” in option 2 includes “N_{TA,common}” in option 2-2 as its meaning.

### Specific Example 1 of Example 1: Option 1 in Case of RRC Connected

A fixed beam appearing in the following description is a beam whose coverage area on the ground surface is fixed, and a moving beam is a beam whose coverage area on the ground surface changes.

If the beam of the satellite 30 is a fixed beam, the position of the reference point does not change. Therefore, the terminal 20 can calculate N_{TA,UE-common} using the position acquired in the RRC idle/inactive state.

When the beam of the satellite 30 is a moving beam, the position of the reference point also changes in accordance with the movement of the satellite 30. Therefore, the base station 10 needs to broadcast or notify the position of the reference point more frequently (at a higher cycle).

### Specific Example 1 of Example 1: Option 2 in Case of RRC Connected

When the beam of the satellite 30 is a fixed beam, N_{TA,UE-common} also changes according to the movement of the satellite 30. Therefore, the base station 10 needs to broadcast or notify N_{TA,UE-common} more frequently (at a higher cycle).

If the beam of the satellite 30 is a moving beam, N_{TA,UE-common} does not change (the beam moves so that N_{TA,UE-common} does not change). Therefore, the terminal 20 can use N_{TA,UE-common} derived in the RRC idle/inactive state.

From the perspective of reducing signaling overhead, it is preferable to use option 1 for the fixed beam and option 2 for the moving beam.

### Specific Example 2 of Example 1

In the specific example 2, N_{TA,UE-common} is calculated using a point at the shortest distance from the satellite 30 to the ground as a reference point. Hereinafter, a case where the terminal 20 is in an RRC idle/inactive state and a case where the terminal 20 is in an RRC connected state will be described separately. The following option 1 and option 2 correspond to option 1 and option 2 described above respectively.

### Specific Example 2 of Example 1: Case of RRC Idle/Inactive

In option 1, the base station 10 notifies or broadcasts the position of the reference point to the terminal 20, and the terminal 20 calculates N_{TA,UE-common} and uses the calculated N_{TA,UE-common} for TA calculation.

In option 2, the base station 10 calculates N_{TA,UE-common} and notifies or broadcasts the calculated N_{TA,UE-common} to the terminal 20. The terminal 20 calculates T_{A} using N_{TA,UE-common} notified from the base station 10.

### Specific Example 2: Case of RRC Connected

In option 1, the position of the reference point changes in accordance with the movement of the satellite 30, regardless of whether the beam of the satellite 30 is a fixed beam or a moving beam. Therefore, the base station 10 needs to broadcast or notify the position of the reference point more frequently (at a higher cycle).

In option 2, N_{TA,UE-common} does not change regardless whether the beam of the satellite 30 is a fixed beam or a moving beam. N_{TA,UE-common} is the minimum RTT between the satellite 30 and the ground plane. Therefore, the terminal 20 can use N_{TA,UE-common} derived in the RRC idle/inactive state.

According to Example 1 described above, even when the terminal 20 does not have a GNSS positioning function, it is possible to appropriately calculate a timing adjustment value in a non-terrestrial network. In addition to the Example 1, the following Example 2 may be carried out to perform accurate TA control in various cases. However, only the Example 1 may be carried out without carrying out the Example 2. In this case, an existing scheme may be used as an RAR TA command.

### Problem for Example 2

Next, as a problem for Example 2, a problem of the RAR TA command will be described. The reason why the RAR TA command needs to be enhanced will be described below.

In the existing art Rel-17, N_{TA,UE-specific} indicates an RTT between the satellite 30 and the terminal 20. On the other hand, in Rel-18, N_{TA,UE-common} indicates an RTT between the satellite 30 and a reference point of a satellite beam.

There is a distance between the terminal 20 and the reference point. Therefore, N_{TA,UE-common} is not equal to N_{TA,UE-specific}. Therefore, the RAR TA command needs to be enhanced to compensate for the difference between N_{TA,UE-common} and N_{TA,UE-specific}.

There are also cases where a negative TA command is required. The reason is as follows.

When N_{TA,UE-common} is larger than N_{TA,UE-specific} (this may occur in Case 1 described later), T_{TA} calculated by N_{TA,UE-common} is larger than T_{TA} actually required by the terminal 20. In such a case, the base station 10 needs to notify the terminal 20 of a negative value as a timing adjustment value.

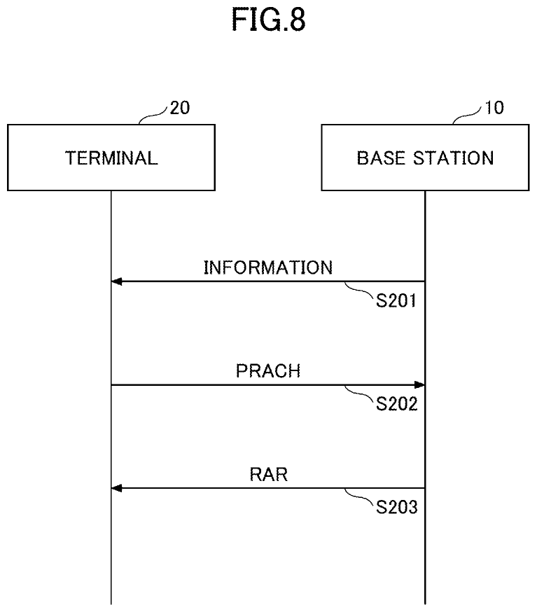

FIG. 8 shows an example of basic operation of Example 2. In S201, the base stations 10 notify the terminal 20 of information. The information is information of parameters such as K and M described later. Note that the timing of S201 may be a timing after PRACH. Also, S201 may be performed simultaneously with S203. In addition, there is a case where S201 is not performed. The information transmitted in S201 may be referred to as auxiliary information.

In S202, the terminal 20 transmits a PRACH to the base station 10. In S203, the base station 10 transmits an RAR to the terminal 20.

Thereafter, for example, the terminal 20 calculates a timing adjustment value for use by using the information of S201 and a timing adjustment value included in an RAR TA command, and transmits an UL signal at a timing based on the calculated timing adjustment value. The base station 10 receives the signal.

Example 2 is divided into Example 2-1 and Example 2-2, and each of them will be described below. Note that, although Example 2 is directed to a TA command of an RAR, this is merely an example. The enhancement of the TA command described in Example 2 may be applied to a TA command of a MAC CE.

### Example 2-1

In Example 2-1, the range of the value of T_{A} notified by the RAR TA command is increased. Hereinafter, option 1 and option 2 (options 2-1 to 2-6) in Example 2-1 will be described. After a full discussion of these options, a detailed example is provided.

### Example 2-1: Option 1

In option 1, the number of bits of the RAR TA command is increased.

In contrast, in each option of option 2 described below, a method of not changing the existing RAR TA command will be described.

### Example 2-1: Option 2-1

In option 2-1, the granularity of N_{TA} calculated by the RAR TA command is increased. The granularity may be defined in advance, or may be notified from the base station 10 to the terminal 20 by SIB, RRC, MAC CE, or DCI.

### Example 2-1: Option 2-2

In option 2-2, a scaling factor (example: K) is notified from the base station 10 to the terminal 20 by SIB, RRC, MAC CE, or DCI. The enhanced N_{TA} or T_{A} in this Example can be calculated by multiplying the legacy N_{TA} or T_{A} notified by the RAR TA command by the scaling factor K.

### Example 2-1: Option 2-3

In option 2-3, an offset value (example: M) is notified from the base station 10 to the terminal 20 by SIB, RRC, MAC CE, or DCI. The enhanced N_{TA} or T_{A} of this Example can be calculated by the sum of the legacy N_{TA} Or T_{A} notified by the RAR TA command and the offset value M.

### Example 2-1: Option 2-4

In option 2-4, an offset value M is calculated by X_M×G_M. X_M is a parameter notified from the base station 10 to the terminal 20. G_M is the granularity of M, and may be defined in advance, or may be notified from the base station 10 to the terminal 20 by SIB, RRC, MAC CE, or DCI. The enhanced N_{TA} or T_{A} of this Example can be calculated by the sum of the legacy N_{TA} or T_{A} notified by the RAR TA command and the offset value M.

### Example 2-1: Option 2-5

In option 2-5, an offset value M is calculated by a1·2^{x1}+a2·2^{x2}+a3·2^{x3}+a4·2^{x4}+ . . . {a1 a2 a3 a4 . . . } are parameters notified from the base station 10 to the terminal 20. {x1 x2 x3 x4 . . . } may be defined in advance or may be notified from the base station 10 to the terminal 20 by SIB, RRC, MAC CE, or DCI. The enhanced N_{TA} Or T_{A} of this Example can be calculated by the sum of the legacy N_{TA} or T_{A} notified by the RAR TA command and the offset value M.

### Example 2-1: Option 2-6

In option 2-6, LSB of X (example: 12) of the enhanced T_{A} is notified from the base station 10 to the terminal 20 by the existing RAR TA command, and MSB of Y of the enhanced T_{A} is notified from the base station 10 to the terminal 20 by SIB, RRC, MAC CE, or DCI as a new notification different from X.

Alternatively, as a variation, MSB of X of the enhanced T_{A} may be notified from the base station 10 to the terminal 20 by the existing RAR TA command, and LSB of Y of the enhanced T_{A} may be notified from the base station 10 to the terminal 20 by SIB, RRC, MAC CE, or DCI as a new notification different from X.

Hereinafter, specific examples of options 2-1 to 2-6 of Example 2-1 will be described.

### Example 2-1: Option 2-1, Specific Example

In option 2-1, the terminal 20 increases the granularity of N_{TA} calculated by the RAR TA command.

In Rel-17, N_{TA}=T_{A}·16·64/2^{μ} holds true, and T_{A} (=0, 1, 2, . . . , 3846) is indicated by a 12-bit TAC field in an RAR. In Rel-18, the granularity of T_{A} can be increased by n times. That is, N_{TA}=T_{A}·n·16·64/2^{μ} holds true.

### Example 2-1: Option 2-2, Specific Example

In option 2-2, a scaling factor is notified. If the scaling factor is equal to 2 and T_{A} indicated in the RAR TA command is 2000, the enhanced T_{A} is calculated as enhanced T_{A}=2×T_{A}=4000. The enhanced N_{TA} is calculated as N_{TA}=enhanced T_{A}·16·64/2″=2×T_{A}·16·64/2^{μ}.

### Example 2-1: Option 2-3, Specific Example

In option 2-3, an offset value M is notified. If the offset value M is equal to 300 and T_{A} indicated in the RAR TA command is 3846, the enhanced T_{A} is calculated as enhanced T_{A}=T_{A}+M=4146.

### Example 2-1: Option 2-4, Specific Example

In option 2-4, the offset value M is calculated as X_M×G_M. If X_M is equal to 300 and G_M is equal to 10, and T_{A} indicated in the RAR TA command is 3846, the enhanced T_{A} is calculated as enhanced T_{A}=T_{A}+X_M×G_M=6846.

### Example 2-1: Option 2-5, Specific Example

In option 2-5, the offset value M is calculated as a1·2^{x1}+a2·2^{x2}+a3·2^{x3}+a4·2^{x4}+ . . . . If {a1 a2 a3 a4}={0 0 0 1} and {x1 x2 x3 x4}={15 14 13 12}, the offset M is calculated as 0·2¹⁵+0·2¹⁴+0·2¹³+1·2¹². The enhanced T_{A} is calculated as enhanced T_{A}=(T_{A} indicated in legacy RAR TAC)+M. Note that in this example, option 2-5 can be considered identical to option 2-6.

### Example 2-1: Option 2-6, Specific Example

In option 2-6, LSB of X of the enhanced T_{A} is notified from the base station 10 to the terminal 20 by the existing RAR TA command, and MSB of Y of the enhanced T_{A} is notified from the base station 10 to the terminal 20 by SIB, RRC, MAC CE, or DCI as a new notification different from X.

If the existing RAR TA command indicates a 12-bit value 111111111111 for X and a 4-bit value 0101 for Y, the enhanced T_{A} is 0101111111111111.

### Example 2-2

Next, Example 2-2 will be described.

In Example 2-2, an example of notifying a negative TA value by the RAR TA command will be described. Hereinafter, the options 1 to 3 will be described.

### Example 2-2: Option 1

In option 1, a 1-bit index value is added to a TA value (a bipolar TA value) that can take a positive value or a negative value in the RAR TA command. That is, the RAR TA command includes the TA value and the 1-bit index value. The 1-bit index value indicates whether the TA value signaled by the RAR TA command is negative or positive.

As a variation, the 1-bit index value may be notified from the base station 10 to the terminal 20 by RRC, MAC CE, or DCI separately from the RAR TA command.

### Example 2-2: Option 2

In option 2, in order to indicate whether TA is positive or negative, values of different ranges are notified, by the RAR TA command, depending on whether the TA is positive or negative. For example, values ranging from 0 to X indicate a positive TA, and values ranging from X+1 to Y indicate a negative TA.

For example, if a value K between 0 and X is notified, the terminal 20 sets a positive TA to K. When a value K between X+1 and Y is notified, the terminal 20 sets the negative TA to X−K.

### Example 2-2: Option 3

According to case 2 described later, a negative TA in the RAR TA command can be avoided. In case 2, RTT between the satellite 30 and the reference point is the minimum value of RTT between the satellite 30 and the ground. RTT between the satellite 30 and the terminal 20 is larger than the RTT between the satellite 30 and the reference point. Therefore, in case 2, negative TA can be avoided.

Hereinafter, as specific examples of Example 2, case 1 and case 2 will be described. Here, the number of bits that need to be added in the RAR TA command is calculated.

### Example 2, Case 1

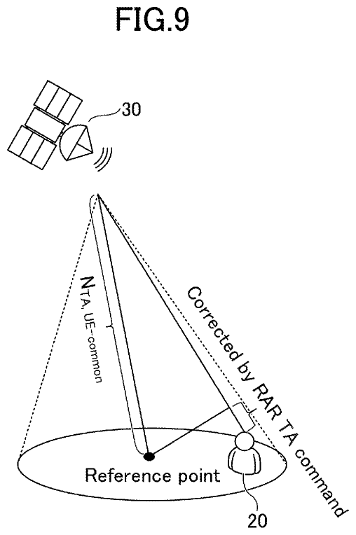

In case 1, as shown in FIG. 9, the reference point is the center point of the satellite beam (the center point of the coverage area). The GEO satellite having the maximum coverage will be described as an example. The coverage of the GEO satellites is 3500 km and its elevation is 35786 km, the signal propagation is calculated using the speed of light.

If the satellite is directly above the beam center and the terminal 20 is at the edge of the beam, the maximum number of bits is required for the RAR TA command. In this case, the difference between the distances between the satellite 30 and the terminal 20 and between the satellite 30 and the reference point is 170750 m, and the delay time due to the difference is 0.0011 s.

When the subcarrier spacing is 2⁴·15 KHZ, the maximum value of the number of bits of the RAR TA command is 16.

In the case of a moving beam, the distance between the satellite 30 and the reference point is the minimum distance, and only positive values are required. Therefore, the number of bits of the RAR TA command is 16. For a fixed beam, the distance between the satellite and the reference point varies, so both negative and positive values are required.

### Example 2, Case 2

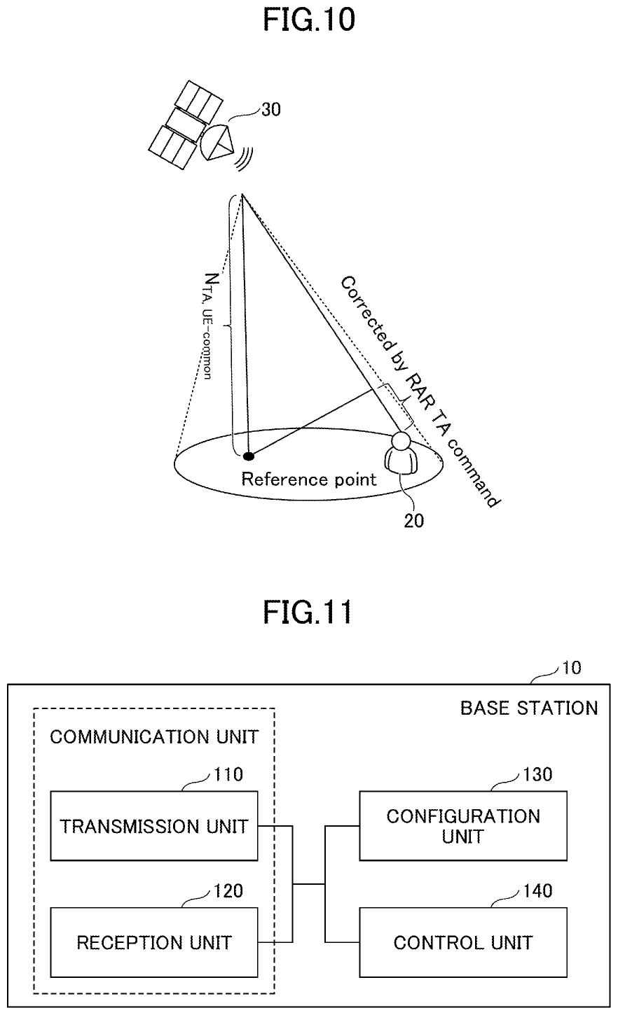

In case 2, as shown in FIG. 10, the point at which the distance between the satellite 30 and the ground is the shortest is set as the reference point.

Here, the description will be given by taking the GEO satellite having the maximum coverage as an example. The coverage of the GEO satellites is 3500 km and its elevation is 35786 km, the signal propagation is calculated using the speed of light.

In the case of a fixed beam, the maximum number of bits is required for the RAR TA command, assuming that the satellite is directly above the beam center and the terminal 20 is at the edge of the beam. In this case, the difference between the distances between the satellite 30 and the terminal 20 and between the satellite 30 and the reference point is 678200 m, and the delay time due to the difference is 0.0045 s.

When the subcarrier spacing is 24.15 KHz, the maximum value of the number of bits of the RAR TA command is 18. For a moving beam, the calculation method is the same as in case 1, and 16 bits are required.

According to Example 2 described above, even when the terminal does not have a positioning function, it is possible to appropriately calculate the timing adjustment value in the non-terrestrial network. In the above description, Example 2 is based on Example 1, but Example 2 may be carried out independently of Example 1.

### Other Examples

Examples common to Example 1 and Example 2 will be described.

Both or one of information (UE capability) notified from the terminal 20 to the base station 10 and information (support information on the network side) notified from the base station 10 to the terminal 20 by higher layer signaling may be used. Examples of the information are as follows.
(1) Information indicating whether or not a GNSS positioning function is supported;
(2) Information indicating whether or not TA without assistance of GNSS positioning function is supported;
(3) Information indicating whether or not TA calculation using N_{TA,UE-common} described in Example 1 is supported;
(4) Information indicating whether or not enhanced N_{TA,common} described in option 2-2 of Example 1 is supported;
(5) Information indicating whether or not the enhanced TA command is supported in the RAR described in Example 2. Detailed examples of (5) are as described in the following.
(a) Information indicating whether or not an increased number of bits in the TAC of the RAR is supported;
(b) Information indicating whether or not increased granularity of TA indicated by the TAC of the RAR in option 1 of Example 2-1 is supported;
(c) Information indicating whether or not new notification of offset/scaling factor in options 2-2 to 2-6 of Example 2-1 is supported;
(d) Information indicating whether or not negative TA notified by the TAC of the RAR is supported.

The functions described in Example 1 and Example 2 may be applied only when the terminal 20 supports the UE capability corresponding to the functions (for example, the above-described (1) to (5)). In addition, in only a case where a certain function (example: the above-described (1) to (5)) is activated for the terminal 20 by higher layer signaling transmitted from the base station 10 to the terminal 20, the function may be applied.

### (Apparatus Configuration)

Next, functional configuration examples of the base station 10 and the terminal 20 that execute the processes and operations described above will be described.

### <Base Station 10>

FIG. 11 is a diagram illustrating an example of a functional configuration of the base station 10. As illustrated in FIG. 11, the base station 10 includes a transmission unit 110, a reception unit 120, a configuration unit 130, and a control unit 140. The functional configuration shown in FIG. 11 is merely an example. The functional sections and the names of the functional units may be anything as long as the operations according to the embodiment of the present invention can be executed. The transmission unit 110 and the reception unit 120 may be collectively referred to as a communication unit.

The transmission unit 110 includes a function of generating a signal to be transmitted to the terminal 20 side (satellite 30 side) and transmitting the signal by radio. The reception unit 120 includes a function of receiving various signals transmitted from the terminal 20 via the satellite 30 and acquiring, for example, information of a higher layer from the received signals. The transmission unit 110 has a function of transmitting NR-PSS, NR-SSS, NR-PBCH, DL/UL control signal, DCI by PDCCH, data by PDSCH, and the like to the terminal 20.

The configuration unit 130 stores configuration information configured in advance and various kinds of configuration information to be transmitted to the terminal 20 in a storage unit included in the configuration unit 130, and reads the configuration information from the storage unit as necessary.

The control unit 140 performs scheduling of DL reception or UL transmission of the terminal 20 via the transmission unit 110. The functional unit related to signal transmission in the control unit 140 may be included in the transmission unit 110, and the functional unit related to signal reception in the control unit 140 may be included in the reception unit 120. The transmission unit 110 may be referred to as a transmitter, and the reception unit 120 may be referred to as a receiver.

### <Terminal 20>

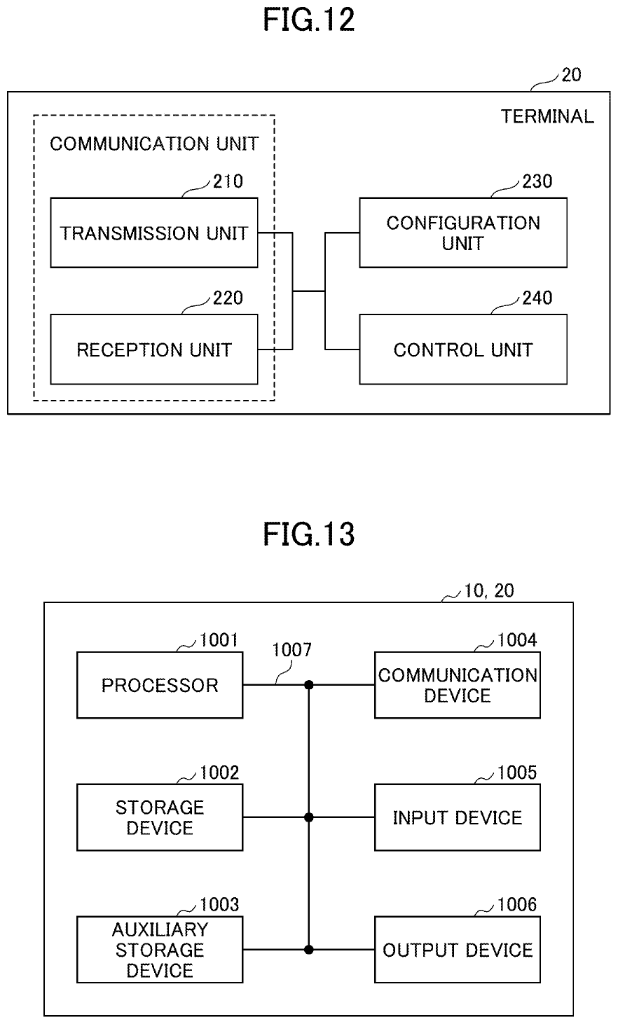

FIG. 12 is a diagram illustrating an example of a functional configuration of the terminal 20. As illustrated in FIG. 12, the terminal 20 includes a transmission unit 210, a reception unit 220, a configuration unit 230, and a control unit 240. The functional configuration shown in FIG. 12 is merely an example. The functional sections and the names of the functional units may be anything as long as the operations according to the embodiment of the present invention can be executed. The transmission unit 210 and the reception unit 220 may be collectively referred to as a communication unit.

The transmission unit 210 creates a transmission signal from the transmission data and transmits the transmission signal by radio. The reception unit 220 receives various signals by radio and acquires a signal of a higher layer from the received signal of the physical layer. Also, the reception unit 220 has a function of receiving NR-PSS, NR-SSS, NR-PBCH, DL/UL/SL control signal, DCI by PDCCH, data by PDSCH and so on, transmitted from the base station 10.

The configuration unit 230 stores various types of configuration information received from the base stations 10 or other terminals by the reception unit 220 in a storage unit included in the configuration unit 230, and reads the information from the storage unit as necessary. The configuration unit 230 also stores configuration information configured in advance. The control unit 240 controls the terminal 20.

The terminal and the base station of Example 1 may be configured as a terminal and a base station described in the following items.

### (Item 1)

A terminal including:
a reception unit configured to receive, from a base station, a position of a reference point that is used for calculation of a timing adjustment value for uplink transmission in a non-terrestrial network; and
a control unit configured to calculate the timing adjustment value based on orbital information of a relay apparatus in the non-terrestrial network and the position of the reference point.

### (Item 2)

A terminal including:
a reception unit configured to receive, from a base station, a timing adjustment value for uplink transmission in a non-terrestrial network, the timing adjustment value being calculated by the base station based on a position of a reference point; and
a control unit configured to adjust a timing of uplink transmission using the timing adjustment value.

### (Item 3)

The terminal as described in item 2,
wherein the reception unit receives, from the base station, the timing adjustment value and a common timing adjustment value that is based on a delay between a relay apparatus in the non-terrestrial network and the base station.

### (Item 4)

The terminal as described in item 2,
wherein the reception unit receives, from the base station, a value including the timing adjustment value as a common timing adjustment value that is based on a delay between a relay apparatus in the non-terrestrial network and the base station.

### (Item 5)

A base station including:

a transmission unit configured to transmit, to a terminal, a position of a reference point that is used for calculation of a timing adjustment value for uplink transmission in a non-terrestrial network; and
a reception unit configured to receive a signal transmitted from the terminal at a timing based on
   the timing adjustment value calculated using an orbital information of a relay apparatus in the non-terrestrial network and the position of the reference point.

### (Item 6)

A base station including:

a transmission unit configured to transmit, to a terminal, a timing adjustment value for uplink transmission in a non-terrestrial network, the timing adjustment value being calculated based on a position of a reference point; and
a reception unit configured to receive a signal transmitted by the terminal at a timing based on the timing adjustment value.

According to any of the items 1 to 6, even when the terminal does not have a positioning function, it is possible to appropriately calculate the timing adjustment value in the non-terrestrial network. According to item 3, since the common timing adjustment value of the existing technique and the timing adjustment value of the embodiment may be transmitted, it is possible to perform quick introduction. According to item 4, it is possible to reduce the amount of signaling.

The terminal and the base station of Example 2 may be configured as a terminal and a base station described in the following items.

### (Item 1)

A terminal including:
a reception unit configured to receive a command that designates a first timing adjustment value and information from a base station; and
a control unit configured to calculate a second timing adjustment value that is used for uplink transmission in a non-terrestrial network using the information and the first timing adjustment value.

### (Item 2)

The terminal as described in item 1, wherein the information is a scaling factor, and the control unit calculates the second timing adjustment value by multiplying the first timing adjustment value by the scaling factor.

### (Item 3)

The terminal as described in item 1, wherein the information is an offset value, and the control unit calculates the second timing adjustment value by calculating a sum of the offset value and the first timing adjustment value.

### (Item 4)

The terminal as described in item 1, wherein the information is auxiliary information for calculating an offset value, and the control unit calculates the offset value using the auxiliary information, and calculates the second timing adjustment value by calculating a sum of the offset value and the first timing adjustment value.

### (Item 5)

The terminal as described in item 1, wherein the control unit calculates the second timing adjustment value by concatenating a bit sequence of the information and a bit sequence of the first timing adjustment value.

### (Item 6)

A base station including:
a transmission unit configured to transmit a command that designates a first timing adjustment value and information to a terminal; and
a reception unit configured to receive a signal transmitted from the terminal based on a second timing adjustment value, for uplink transmission in a non-terrestrial network, that is calculated using the information and the first timing adjustment value.

According to any of the items 1 to 6, even when the terminal does not have a positioning function, it is possible to appropriately calculate the timing adjustment value in the non-terrestrial network. According to items 2 to 5, the second timing adjustment value can be appropriately calculated.

### (Hardware Configuration)

The block diagrams (FIG. 11 and FIG. 12) used in the description of the embodiment described above illustrate the block of functional unit. Such functional blocks (configuration parts) are attained by at least one arbitrary combination of hardware and software. In addition, an attainment method of each of the function blocks is not particularly limited. That is, each of the function blocks may be attained by using one apparatus that is physically or logically coupled, by directly or indirectly (for example, in a wired manner, over the radio, or the like) connecting two or more apparatuses that are physically or logically separated and by using such a plurality of apparatuses. The function block may be attained by combining one apparatus described above or a plurality of apparatuses described above with software.

The function includes determining, judging, calculating, computing, processing, deriving, investigating, looking up, ascertaining, receiving, transmitting, output, accessing, resolving, selecting, choosing, establishing, comparing, assuming, expecting, presuming, broadcasting, notifying, communicating, forwarding, configuring, reconfiguring, allocating (mapping), assigning, and the like, but is not limited thereto. For example, a function block (a configuration part) that functions transmission is referred to as the transmitting unit or the transmitter. As described above, the attainment method thereof is not particularly limited.

For example, the base station 10, the terminal 20, and the like in one embodiment of this disclosure may function as a computer for performing the processing of a radio communication method of this disclosure. FIG. 13 is a diagram illustrating an example of a hardware configuration of the base station 10 and the terminal 20 according to one embodiment of this disclosure. The base station 10 and the terminal 20 described above may be physically configured as a computer apparatus including a processor 1001, a storage device 1002, an auxiliary storage device 1003, a communication device 1004, an input device 1005, an output device 1006, a bus 1007, and the like.

Note that, in the following description, the word “apparatus” can be replaced with a circuit, a device, a unit, or the like. The hardware configuration of the base station 10 and the terminal 20 may be configured to include one or a plurality of apparatuses illustrated in the drawings, or may be configured not to include a part of the apparatuses.

Each function of the base station 10 and the terminal 20 is attained by reading predetermined software (a program) on hardware such as the processor 1001 and the storage device 1002 such that the processor 1001 performs an operation, and by controlling the communication of the communication device 1004 or by controlling at least one of reading and writing of data in the storage device 1002 and the auxiliary storage device 1003.

The processor 1001, for example, controls the entire computer by operating an operating system. The processor 1001 may be configured by a central processing unit (CPU) including an interface with respect to the peripheral equipment, a control apparatus, an operation apparatus, a register, and the like. For example, the control unit 140, the control unit 240, or the like, described above, may be attained by the processor 1001.

In addition, the processor 1001 reads out a program (a program code), a software module, data, and the like to the storage device 1002 from at least one of the auxiliary storage device 1003 and the communication device 1004, and thus, executes various processing. A program for allowing a computer to execute at least a part of the operation described in the embodiment described above is used as the program. For example, the control unit 140 of the base station 10 illustrated in FIG. 11 may be attained by a control program that is stored in the storage device 1002 and is operated by the processor 1001. In addition, for example, the control unit 240 of the terminal 20 illustrated in FIG. 12 may be attained by a control program that is stored in the storage device 1002 and is operated by the processor 1001. It has been described that the various processing above are executed by one processor 1001, but the various processing may be simultaneously or sequentially executed by two or more processors 1001. The processor 1001 may be mounted on one or more chips. Note that, the program may be transmitted from a network through an electric communication line.

The storage device 1002 is a computer readable recording medium, and for example, may be configured of at least one of a read only memory (ROM), an erasable programmable ROM (EPROM), an electrically erasable programmable ROM (EEPROM), a random access memory (RAM), and the like. The storage device 1002 may be referred to as a register, a cache, a main memory (a main storage unit), and the like. The storage device 1002 is capable of retaining a program (a program code), a software module, and the like that can be executed in order to implement a communication method according to one embodiment of this disclosure.

The auxiliary storage device 1003 is a computer readable recording medium, and for example, may be configured of at least one of an optical disk such as a compact disc ROM (CD-ROM), a hard disk drive, a flexible disk, a magnetooptical disk (for example, a compact disc, a digital versatile disk, and a Blu-ray (Registered Trademark) disk), a smart card, a flash memory (for example, a card, a stick, a key drive), a floppy (Registered Trademark) disk, a magnetic strip, and the like. The auxiliary storage device 1003 may be referred to as an auxiliary storage unit. The storage medium described above, for example, may be a database including at least one of the storage device 1002 and the auxiliary storage device 1003, a server, and a suitable medium.

The communication device 1004 is hardware (a transmitting and receiving device) for performing communication with respect to the computer through at least one of a wire network and a radio network, and for example, is also referred to as a network device, a network controller, a network card, a communication module, and the like. The communication device 1004, for example, may be configured by including a high frequency switch, a duplexer, a filter, a frequency synthesizer, and the like, in order to attain at least one of frequency division duplex (FDD) and time division duplex (TDD). For example, a transmitting and receiving antenna, an amplifier, a transmitting and receiving unit, a transmission path interface, and the like may be attained by the communication device 1004. In the transmitting and receiving unit, the transmitting unit and the receiving unit are mounted by being physically or logically separated.

The input device 1005 is an input device for receiving input from the outside (for example, a keyboard, a mouse, a microphone, a switch, a button, a sensor, and the like). The output device 1006 is an output device for implementing output with respect to the outside (for example, a display, a speaker, an LED lamp, and the like). Note that, the input device 1005 and the output device 1006 may be integrally configured (for example, a touch panel).

In addition, each of the apparatuses such as the processor 1001 and the storage device 1002 may be connected by the bus 1007 for performing communication with respect to information. The bus 1007 may be configured by using a single bus, or may be configured by using buses different for each of the apparatuses.

In addition, the base station 10 and the terminal 20 may be configured by including hardware such as a microprocessor, a digital signal processor (DSP), an application specific integrated circuit (ASIC), a programmable logic device (PLD), and a field programmable gate array (FPGA), and a part or all of the respective function blocks may be attained by the hardware. For example, the processor 1001 may be mounted by using at least one of the hardware.

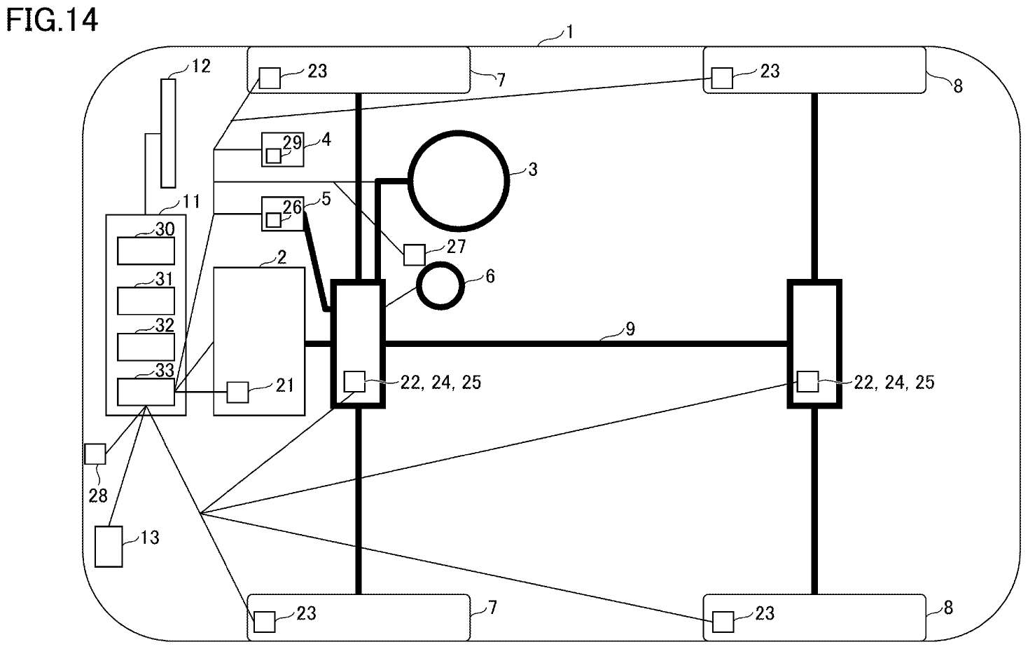

The terminal 20 or the base station 10 may be provided in a vehicle 1. FIG. 14 shows a configuration example of the vehicle 1.

As shown in FIG. 14, the vehicle 1 includes a drive unit 2, a steering unit 3, an accelerator pedal 4, a brake pedal 5, a shift lever 6, left and right front wheels 7, left and right rear wheels 8, an axle 9, an electronic control unit 11, various sensors 21-29, an information service unit 12, and a communication module 13.

The drive unit 2 may include, for example, an engine, a motor, and a hybrid of an engine and a motor. The steering unit 3 includes at least a steering wheel and is configured to steer at least one of the front wheels and the rear wheels, based on the operation of the steering wheel operated by the user.

The electronic control unit 11 includes a microprocessor 31, a memory (ROM, RAM) 32, and a communication port (IO port) 33. The electronic control unit 11 receives signals from the various sensors 21-27 provided in the vehicle. The electronic control unit 11 may be referred to as an ECU (Electronic control unit).

The signals from the various sensors 21 to 28 include a current signal from a current sensor 21 which senses the current of the motor, a front or rear wheel rotation signal acquired by a revolution sensor 22, a front or rear wheel pneumatic signal acquired by a pneumatic sensor 23, a vehicle speed signal acquired by a vehicle speed sensor 24, an acceleration signal acquired by an acceleration sensor 25, a stepped-on accelerator pedal signal acquired by an accelerator pedal sensor 29, a stepped-on brake pedal signal acquired by a brake pedal sensor 26, an operation signal of a shift lever acquired by a shift lever sensor 27, and a detection signal, acquired by the object detection sensor 28, for detecting an obstacle, a vehicle, a pedestrian, and the like.

The information service unit 12 includes various devices for providing various kinds of information such as driving information, traffic information, and entertainment information, including a car navigation system, an audio system, a speaker, a television, and a radio, and one or more ECUs controlling these devices. The information service unit 12 provides various types of multimedia information and multimedia services to the occupants of the vehicle 1 by using information obtained from the external device through the communication module 13 or the like.

A driving support system unit 30 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 30 transmits and receives various types of information via the communication module 13 to realize a driving support function or an autonomous driving function.

The communication module 13 may communicate with the microprocessor 31 and components of the vehicle 1 via a communication port. For example, the communication module 13 transmits and receives data via the communication port 33, to and from the drive unit 2, the steering unit 3, the accelerator pedal 4, the brake pedal 5, the shift lever 6, the left and right front wheels 7, the left and right rear wheels 8, the axle 9, the microprocessor 31 and the memory (ROM, RAM) 32 in the electronic control unit 11, and sensors 21-28 provided in the vehicle 1.

The communication module 13 is a communication device that can be controlled by the microprocessor 31 of the electronic control unit 11 and that is capable of communicating with external devices. For example, various kinds of information are transmitted to and received from external devices through radio communication. The communication module 13 may be internal to or external to the electronic control unit 11. The external devices may include, for example, a base station, a mobile station, or the like.

The communication module 13 transmits a current signal, which is input to the electronic control unit 11 from the current sensor, to the external devices through radio communication. In addition, the communication module 13 also transmits, to the external devices through radio communication, the front or rear wheel rotation signal acquired by the revolution sensor 22, the front or rear wheel pneumatic signal acquired by the pneumatic sensor 23, the vehicle speed signal acquired by the vehicle speed sensor 24, the acceleration signal acquired by the acceleration sensor 25, the stepped-on accelerator pedal signal acquired by the accelerator pedal sensor 29, the stepped-on brake pedal signal acquired by the brake pedal sensor 26, the operation signal of the shift lever acquired by the shift lever sensor 27, and the detection signal, acquired by the object detection sensor 28, for detecting an obstacle, a vehicle, a pedestrian, and the like, that are input to the electronic control unit 11.

The communication module 13 receives various types of information (traffic information, signal information, inter-vehicle information, etc.) transmitted from the external devices and displays the received information on the information service unit 12 provided in the vehicle 1. In addition, the communication module 13 stores the various types of information received from the external devices in the memory 32 available to the microprocessor 31. Based on the information stored in the memory 32, the microprocessor 31 may control the drive unit 2, the steering unit 3, the accelerator pedal 4, the brake pedal 5, the shift lever 6, the front wheels 7 of left and right, the rear wheels 8 of left and right, the axle 9, the sensors 21-28, etc., mounted in the vehicle 1.

The terminal 20 or the base station 10 described in the present embodiment may be used as the communication module 13.

### Supplement to Embodiment

As described above, the embodiment of the invention has been described, but the disclosed invention is not limited to the embodiment, and a person skilled in the art will understand various modification examples, correction examples, alternative examples, substitution examples, and the like. Specific numerical examples have been described in order to facilitate the understanding of the invention, but the numerical values are merely an example, and any appropriate values may be used, unless otherwise specified. The classification of the items in the above description is not essential to the invention, and the listings described in two or more items may be used by being combined, as necessary, or the listing described in one item may be applied to the listing described in another item (insofar as there is no contradiction). A boundary between the functional parts or the processing parts in the function block diagram does not necessarily correspond to a boundary between physical components. The operations of a plurality of functional parts may be physically performed by one component, or the operation of one functional part may be physically performed by a plurality of components. In a processing procedure described in the embodiment, a processing order may be changed, insofar as there is no contradiction. For the convenience of describing the processing, the base station 10 and the terminal 20 have been described by using a functional block diagram, but such an apparatus may be attained by hardware, software, or a combination thereof. Each of software that is operated by a processor of the base station 10 according to the embodiment of the invention and software that is operated by a processor of the terminal 20 according to the embodiment of the invention may be retained in a random access memory (RAM), a flash memory, a read only memory (ROM), an EPROM, an EEPROM, a register, a hard disk (HDD), a removable disk, a CD-ROM, a database, a server, and other suitable recording media.

In addition, the notification of the information is not limited to the aspect/embodiment described in this disclosure, and may be performed by using other methods. For example, the notification of the information may be implemented by physical layer signaling (for example, downlink control information (DCI) and uplink control information (UCI)), higher layer signaling (for example, radio resource control (RRC) signaling, medium access control (MAC) signaling, broadcast information (a master information block (MIB)), a system information block (SIB)), other signals, or a combination thereof. In addition, the RRC signaling may be referred to as an RRC message, and for example, may be an RRC connection setup message, an RRC connection reconfiguration message, and the like.

Each aspect/embodiment described in this disclosure may be applied to a system using long term evolution (LTE), LTE-advanced (LTE-A), SUPER 3G, IMT-advanced, a 4th generation mobile communication system (4G), a 5th generation mobile communication system (5G), 6th generation mobile communication system (6G), xth generation mobile communication system (xG) (x is an integer or decimal, for example), future radio access (FRA), new radio (NR), new radio access (NX), future generation radio access (FX), W-CDMA (Registered Trademark), GSM (Registered Trademark), CDMA2000, an ultra mobile broadband (UMB), IEEE 802.11 (Wi-Fi (Registered Trademark)), IEEE 802.16 (WiMAX (Registered Trademark)), IEEE 802.20, an ultra-wideband (UWB), Bluetooth (Registered Trademark), and other suitable systems and a next-generation system that is expanded on the basis thereof. In addition, a combination of a plurality of systems (for example, a combination of at least one of LTE and LTE-A and 5G, and the like) may be applied.

In the processing procedure, the sequence, the flowchart, and the like of each aspect/embodiment described herein, the order may be changed, insofar as there is no contradiction. For example, in the method described in this disclosure, the elements of various steps are presented by using an exemplary order, but are not limited to the presented specific order.

Here, a specific operation that is performed by the base station 10 may be performed by an upper node, in accordance with a case. In a network provided with one or a plurality of network nodes including the base station 10, it is obvious that various operations that are performed in order for communication with respect to the terminal 20 can be performed by at least one of the base station 10 and network nodes other than the base station 10 (for example, MME, S-GW, or the like is considered as the network node, but the network node is not limited thereto). In the above description, a case is exemplified in which the number of network nodes other than the base station 10 is 1, but a plurality of other network nodes may be combined (for example, the MME and the S-GW).

The information, the signal, or the like described in this disclosure can be output to a lower layer (or the higher layer) from the higher layer (or the lower layer). The information, the signal, or the like may be input and output through a plurality of network nodes.

The information or the like that is input and output may be retained in a specific location (for example, a memory), or may be managed by using a management table. The information or the like that is input and output can be subjected to overwriting, updating, or editing. The information or the like that is output may be deleted. The information or the like that is input may be transmitted to the other apparatuses.

Judgment in this disclosure may be performed by a value represented by 1 bit (0 or 1), may be performed by a truth-value (Boolean: true or false), or may be performed by a numerical comparison (for example, a comparison with a predetermined value).

Regardless of whether the software is referred to as software, firmware, middleware, a microcode, and a hardware description language, or is referred to as other names, the software should be broadly interpreted to indicate a command, a command set, a code, a code segment, a program code, a program, a sub-program, a software module, an application, a software application, a software package, a routine, a sub-routine, an object, an executable file, an execution thread, a procedure, a function, and the like.

In addition, software, a command, information, and the like may be transmitted and received through a transmission medium. For example, in a case where the software is transmitted from a website, a server, or other remote sources by using at least one of a wire technology (a coaxial cable, an optical fiber cable, a twisted pair, a digital subscriber line (DSL), and the like) and a radio technology (an infrared ray, a microwave, and the like), at least one of the wire technology and the radio technology is included in the definition of the transmission medium.

The information, the signal, and the like described in this disclosure may be represented by using any of various different technologies. For example, the data, the command, the command, the information, the signal, the bit, the symbol, the chip, and the like that can be referred to through the entire description described above may be represented by a voltage, a current, an electromagnetic wave, a magnetic field or magnetic particles, an optical field or a photon, or an arbitrary combination thereof.

Note that, the terms described in this disclosure and the terms necessary for understanding this disclosure may be replaced with terms having the same or similar meaning. For example, at least one of the channel and the symbol may be a signal (signaling). In addition, the signal may be a message. In addition, a component carrier (CC) may be referred to as a carrier frequency, a cell, a frequency carrier, and the like.

The terms “system” and “network” used in this disclosure are interchangeably used.

In addition, the information, the parameter, and the like described in this disclosure may be represented by using an absolute value, may be represented by using a relative value from a predetermined value, or may be represented by using another corresponding information. For example, a radio resource may be indicated by an index.

The names used in the parameters described above are not a limited name in any respect. Further, expressions or the like using such parameters may be different from those explicitly disclosed in this disclosure. Various channels (for example, PUSCH, PUCCH, PDCCH, and the like) and information elements can be identified by any suitable name, and thus, various names that are allocated to such various channels and information elements are not a limited name in any respect.

In this disclosure, the terms “base station (BS)”, “radio base station”, “base station”, “fixed station”, “NodeB”, “eNodeB (eNB)”, “gNodeB (gNB)”, “access point”, “transmission point”, “reception point”, “transmission and reception point”, “cell”, “sector”, “cell group”, “carrier”, “component carrier”, and the like can be interchangeably used. The base station may be referred to by a term such as a macro-cell, a small cell, a femtocell, and a picocell.

The base station is capable of accommodating one or a plurality of (for example, three) cells. In a case where the base station accommodates a plurality of cells, the entire coverage area of the base station can be classified into a plurality of small areas, and each of the small areas is capable of providing communication service by a base station sub-system (for example, an indoor type small base station (a remote radio head (RRH)). The term “cell” or “sector” indicates a part of the coverage area or the entire coverage area of at least one of the base station and the base station sub-system that perform the communication service in the coverage.

In this disclosure, the terms “mobile station (MS)”, “user terminal”, “user equipment (UE)”, and “terminal” can be interchangeably used.

The mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a terminal, a wireless terminal, a remote terminal, a handset, a user agent, a mobile client, a client, or other suitable terms, by a person skilled in the art.

At least one of the base station and the mobile station may be referred to as a transmitting apparatus, a receiving apparatus, a communication apparatus, and the like. Note that, at least one of the base station and the mobile station may be a device that is mounted on a mobile object, the mobile object itself, or the like. The mobile object may be a vehicle (for example, a car, an airplane, and the like), may be a mobile object that is moved in an unmanned state (for example, a drone, an autonomous driving car, and the like), or may be a (manned or unmanned) robot. Note that, at least one of the base station and the mobile station also includes an apparatus that is not necessarily moved at the time of a communication operation. For example, at least one of the base station and the mobile station may be an internet of things (IoT) device such as a sensor.

In addition, the base station in this disclosure may be replaced with the terminal. For example, each aspect/embodiment of this disclosure may be applied to a configuration in which communication between the base station and the terminal is replaced with communication in a plurality of terminals 20 (for example, may be referred to as device-to-device (D2D), vehicle-to-everything (V2X), and the like). In this case, the function of the base station 10 described above may be provided in the terminal 20. In addition, the words “uplink”, “downlink”, and the like may be replaced with words corresponding to the communication between the terminals (for example, “side”). For example, an uplink channel, a downlink channel, and the like may be replaced with a side channel.

Similarly, the terminal in this disclosure may be replaced with the base station. In this case, the function of the user terminal described above may be provided in the base station.

The terms “determining” used in this disclosure may involve diverse operations. “Determining” and “determining”, for example, may include deeming judging, calculating, computing, processing, deriving, investigating, looking up (search, inquiry) (for example, looking up in a table, a database, or another data structure), and ascertaining, as “determining” and “determining”. In addition, “determining” and “determining” may include deeming receiving (for example, receiving information), transmitting (for example, transmitting information), input, output, and accessing (for example, accessing data in a memory), as “determining” and “determining”. In addition, “determining” and “determining” may include deeming resolving, selecting, choosing, establishing, comparing, and the like as “determining” and “determining”. That is, “determining” and “determining” may include deeming an operation as “determining” and “determining”. In addition, “determining (determining)” may be replaced with “assuming”, “expecting”, “considering”, and the like.

The terms “connected” and “coupled”, or any modification thereof indicate any direct or indirect connection or couple in two or more elements, and are capable of including a case where there are one or more intermediate elements between two elements that are “connected” or “coupled” to each other. The couple or connection between the elements may be physical or logical, or may be a combination thereof. For example, the “connection” may be replaced with “access”. In the case of being used in this disclosure, it is possible to consider that two elements are “connected” or “coupled” to each other by using at least one of one or more electric wires, cables, and print electric connection, and as some non-limiting and non-inclusive examples, by using electromagnetic energy having a wavelength of a radio frequency domain, a microwave domain, and an optical (visible and invisible) domain, and the like.

The reference signal can also be abbreviated as RS, and may be referred to as pilot on the basis of a standard to be applied.

The description “on the basis of” that is used in this disclosure does not indicate “only on the basis of”, unless otherwise specified. In other words, the description “on the basis of” indicates both “only on the basis of” and “at least on the basis of”.

Any reference to elements using the designations “first,” “second,” and the like, used in this disclosure, does not generally limit the amount or the order of such elements. Such designations can be used in this disclosure as a convenient method for discriminating two or more elements. Therefore, a reference to a first element and a second element does not indicate that only two elements can be adopted or the first element necessarily precedes the second element in any manner.

“Means” in the configuration of each of the apparatuses described above may be replaced with “unit”, “circuit”, “device”, and the like.

In this disclosure, in a case where “include”, “including”, and the modification thereof are used, such terms are intended to be inclusive, as with the term “comprising”. Further, the term “or” that is used in this disclosure is not intended to be exclusive-OR.

A radio frame may be configured of one or a plurality of frames in a time domain. Each of one or a plurality of frames in the time domain may be referred to as a subframe. The subframe may be further configured of one or a plurality of slots in the time domain. The subframe may be a fixed time length (for example, 1 ms) that does not depend on numerology.

The numerology may be a communication parameter to be applied to at least one of the transmission and the reception of a certain signal or channel. The numerology, for example, may indicate at least one of subcarrier spacing (SCS), a bandwidth, a symbol length, a cyclic prefix length, a transmission time interval (TTI), the number of symbols per TTI, a radio frame configuration, specific filtering processing that is performed by the transceiver in a frequency domain, specific windowing processing that is performed by the transceiver in a time domain, and the like.

The slot may be configured of one or a plurality of symbols (an orthogonal frequency division multiplexing (OFDM) symbol, a single carrier frequency division multiple access (SC-FDMA) symbol, and the like) in a time domain. The slot may be time unit based on the numerology.

The slot may include a plurality of mini slots. Each of the mini slots may be configured of one or a plurality of symbols in the time domain. In addition, the mini slot may be referred to as a subslot. The mini slot may be configured of symbols of which the number is less than that of the slot. PDSCH (or PUSCH) to be transmitted in time units greater than the mini slot may be referred to as a PDSCH (or PUSCH) mapping type A. PDSCH (or PUSCH) to be transmitted by using the mini slot may be referred to as a PDSCH (or PUSCH) mapping type B.

All of the radio frame, the subframe, the slot, the mini slot, and the symbol represent time unit at the time of transmitting a signal. Other names respectively corresponding to the radio frame, the subframe, the slot, the mini slot, and the symbol may be used.

For example, one subframe may be referred to as a transmission time interval (TTI), a plurality of consecutive subframes may be referred to as TTI, or one slot or one mini slot may be referred to as TTI. That is, at least one of the subframe and TTI may be a subframe (1 ms) in the existing LTE, may be a period shorter than 1 ms (for example, 1 to 13 symbols), or may be a period longer than 1 ms. Note that, a unit representing TTI may be referred to as a slot, a mini slot, and the like, but not a subframe.

Here, TTI, for example, indicates a minimum time unit of scheduling in radio communication. For example, in an LTE system, the base station performs scheduling for allocating a radio resource (a frequency bandwidth, transmission power, and the like that can be used in each of the terminals 20) in a TTI unit, with respect to each of the terminals 20. Note that, the definition of TTI is not limited thereto.

TTI may be a transmission time unit of a data packet (a transport block), a code block, a codeword, and the like that are subjected to channel coding, or may be processing unit of scheduling, link adaptation, and the like. Note that, when TTI is applied, a time section (for example, the number of symbols) in which the transport block, the code block, the codeword, and the like are actually mapped may be shorter than TTI.

Note that, in a case where one slot or one mini slot is referred to as TTI, one or more TTIs (that is, one or more slots or one or more mini slots) may be the minimum time unit of the scheduling. In addition, the number of slots (the number of mini slots) configuring the minimum time unit of the scheduling may be controlled.

TTI having a time length of 1 ms may be referred to as a normal TTI (TTI in LTE Rel. 8-12), a normal TTI, a long TTI, a normal subframe, a normal subframe, a long subframe, a slot, and the like. TTI shorter than the normal TTI may be referred to as a shortened TTI, a short TTI, a partial TTI (or a fractional TTI), a shortened subframe, a short subframe, a mini slot, a subslot, a slot, and the like.

Note that, the long TTI (for example, the normal TTI, the subframe, and the like) may be replaced with TTI having a time length of greater than or equal to 1 ms, and the short TTI (for example, the shortened TTI and the like) may be replaced with TTI having a TTI length of less than a TTI length of the long TTI and greater than or equal to 1 ms.

The resource block (RB) is a resource allocation unit of the time domain and the frequency domain, and may include one or a plurality of consecutive subcarriers in the frequency domain. The number of subcarriers included in RB may be the same regardless of the numerology, or for example, may be 12. The number of subcarriers included in RB may be determined on the basis of the numerology.

In addition, the time domain of RB may include one or a plurality of symbols, or may be the length of one slot, one mini slot, one subframe, or one TTI. One TTI, one subframe, and the like may be respectively configured of one or a plurality of resource blocks.

Note that, one or a plurality of RBs may be referred to as a physical resource block (physical RB: PRB), a sub-carrier group (SCG), a resource element group (REG), a PRB pair, an RB pair, and the like.

In addition, the resource block may be configured of one or a plurality of resource elements (RE). For example, one RE may be a radio resource domain of one subcarrier and one symbol.

A bandwidth part (BWP) (may be referred to as a part bandwidth or the like) may represent a subset of consecutive common resource blocks (common RBs) for certain numerology, in a certain carrier. Here, the common RB may be specified by an index of RB based on a common reference point of the carrier. PRB may be defined by a certain BWP, and may be numbered within BWP.

BWP may include BWP for UL (UL BWP) and BWP for DL (DL BWP). In UE, one or a plurality of BWPs may be configured within one carrier.

At least one of the configured BWPs may be active, and it need not be assumed that the UE transmits and receives a predetermined signal/channel out of the active BWP. Note that, the “cell”, the “carrier”, and the like in this disclosure may be replaced with “BWP”.

The structure of the radio frame, the subframe, the slot, the mini slot, the symbol, and the like, described above, is merely an example. For example, the configuration of the number of subframes included in the radio frame, the number of slots per a subframe or a radio frame, the number of mini slots included in the slot, the number of symbols and RBs included in the slot or a mini slot, the number of subcarriers included in RB, the number of symbols in TTI, a symbol length, a cyclic prefix (CP) length, and the like can be variously changed.

In this disclosure, for example, in a case where articles such as a, an, and the are added by translation, this disclosure may include a case where nouns following the articles are in the plural.

In this disclosure, the term “A and B are different” may indicate “A and B are different from each other”. Note that, the term may indicate “A and B are respectively different from C”. The terms “separated”, “coupled”, and the like may be interpreted as with “being different”.

Each aspect/embodiment described in this disclosure may be independently used, may be used by being combined, or may be used by being switched in accordance with execution. In addition, the notification of predetermined information (for example, the notification of “being X”) is not limited to being performed explicitly, and may be performed implicitly (for example, the notification of the predetermined information is not performed).

In the present disclosure, the SS block or CSI-RS is an example of a synchronization signal or reference signal.

As described above, this disclosure has been described in detail, but it is obvious for a person skilled in the art that this disclosure is not limited to the embodiment described in this disclosure. This disclosure can be implemented as corrected and modified without departing from the spirit and scope of this disclosure defined by the description of the claims. Therefore, the description in this disclosure is for illustrative purposes and does not have any limiting meaning with respect to this disclosure.

### DESCRIPTION OF SYMBOLS

10 base station
110 transmission unit
120 reception unit
130 configuration unit
140 control unit
20 terminal
30 satellite
210 transmission unit
220 reception unit
221 passive-type receiver
230 configuration unit
240 control unit
1001 processor
1002 storage device
1003 auxiliary storage device
1004 communication device
1005 input device
1006 output device

1. A terminal comprising:
a reception unit configured to receive a command that designates a first timing adjustment value and information from a base station; and
a control unit configured to calculate a second timing adjustment value that is used for uplink transmission in a non-terrestrial network using the information and the first timing adjustment value.

2. The terminal as claimed in claim 1, wherein the information is a scaling factor, and the control unit calculates the second timing adjustment value by multiplying the first timing adjustment value by the scaling factor.

3. The terminal as claimed in claim 1, wherein the information is an offset value, and the control unit calculates the second timing adjustment value by calculating a sum of the offset value and the first timing adjustment value.

4. The terminal as claimed in claim 1, wherein the information is auxiliary information for calculating an offset value, and the control unit calculates the offset value using the auxiliary information, and calculates the second timing adjustment value by calculating a sum of the offset value and the first timing adjustment value.

5. The terminal as claimed in claim 1, wherein the control unit calculates the second timing adjustment value by concatenating a bit sequence of the information and a bit sequence of the first timing adjustment value.

6. A base station comprising:
a transmission unit configured to transmit a command that designates a first timing adjustment value and information to a terminal; and
a reception unit configured to receive a signal transmitted from the terminal based on a second timing adjustment value, for uplink transmission in a non-terrestrial network, that is calculated using the information and the first timing adjustment value.
